(19) United States
(12) Patent Application Publication
(10) Pub. No.: US 2023/0403555 A1
(43) Pub. Date: Dec. 14, 2023

(54) NOVEL AUTHENTICATION SYSTEM AND METHOD USING AN IMMUTABLE FACTOR COMPRISED OF SECURE DEVICE ID AND GEOLOCATION COMPUTED BY SATELLITE LEO ASSISTANCE

(71) Applicant: Wi-LAN Research Inc., Vista, CA (US)

(72) Inventors: Muddassar Farooq, Islamabad (PK); Taimur Hayat Khan, Islamabad (PK); Arslan Mumtaz, Islamabad (PK); Zain Noman, Islamabad (PK); Kenneth Stanwood, Vista, CA (US); Rashad Ramzan, Islamabad (PK)

(73) Assignee: Wi-LAN Research Inc., Vista, CA (US)

(21) Appl. No.: 18/322,763

(22) Filed: May 24, 2023

Related U.S. Application Data
(60) Provisional application No. 63/350,498, filed on Jun. 9, 2022.

(51) Int. Cl. H04W 12/06; H04W 12/64

(52) U.S. Cl. CPC H04W 12/06; H04W 12/64

(57) ABSTRACT

System and methods for authenticating a UE, using one of two novel immutable factors, for granting access to premium resources. One immutable factor includes a public ID of the UE and its true geolocation, while the other consists of the SDID of UE and its true geolocation. For the public ID based system, a non-terrestrial communication network verifies geolocation of an LBS provider by comparing geolocation with the publicly known geolocation of the LBS provider After receiving true geolocation coordinates, LBS provider grants or denies UE's resource access request by comparing geolocation of UE with the geolocation(s) retrieved from the credential database which contains a list of preauthorized geolocation(s) for the legitimate users of a UE. For the SDID based system, an authentication system verifies SDID of both the requesting UE and LBS provider by comparing transmitted SDID with the SDID retrieved from an SDID database.

### CROSS REFERENCE TO RELATED APPLICATIONS

This application claims priority to U.S. Provisional Patent Application Ser. No. 63/350,498, filed Jun. 9, 2022, titled “Novel Authentication System and Method Using an Immutable Factor Comprised of Secure device ID and Geolocation Computed by Satellite LEO Assistance”, the disclosure of which is incorporated herein by reference.

### FIELD OF THE INVENTION

The disclosed concept described herein discloses location-based access control (LBAC) systems and methods by using one of two novel immutable factors that consist of either a tuple of a public device ID and an accurate and secure geolocation or a tuple of a secret and unique hardwired device ID and an accurate and secure geolocation.

### BACKGROUND OF THE INVENTION

Typically, users who want to remotely access premium or sensitive assets or resources of a business/corporation/government through their devices must first authenticate themselves by sharing their identification credentials and then the system allows them the access to these assets or resources. Due to the rapid advancements in the technology of high-speed communication networks such as 5G/6G networks and beyond, coupled with exponential growth in the semiconductor industry, it is conservatively estimated that at least trillions of devices (mobiles, IoT devices, laptops, etc.) will exchange an unprecedented amount of data at very high data rates. Furthermore, due to an influx of smart applications on heterogenous communication devices, businesses and users require secure and low latency authentication systems to gain access to their digital and/or physical assets. Context-aware and cognition enabled access control systems and methods require additional information—location, device manufacturer, network type—of a user in addition to his username and password to authenticate him as a legitimate user before granting him access to the resources or services. It is an expectation that the disclosed concept will make it significantly difficult to compromise such intelligent access control systems.

For many applications; such as ride-sharing, food delivery, drone delivery, e-health and e-commerce; it is desirable to ascertain the true geolocation of devices, collectively referred to as user equipment (UE) hereafter. Satellite-based location systems such as the US Global Positioning System (GPS) or the European Global Navigation Satellite System (GNSS), though ubiquitously available, are unable to provide a reliable method to UEs to securely determine their own geolocation. Moreover, these systems provide no protection against a compromised device that impersonates the location of some other device or fakes its own location. It is already demonstrated that a malicious entity can transmit fake GPS signals, causing a device to think that it is at a location where it is not. This attack could be applied, for instance, to delivery drones to cause them to deliver their cargo to the wrong location. It is desirable to have a system and method that allows a device to be confident of its true geolocation. Moreover, as mentioned before, malicious UEs—the ones running compromised firmware or specialized firmware with backdoors that may have been installed by rogue entities for espionage—could impersonate the location of other UEs or even fake their own location to Location-based Service (LBS) providers. As a result, LBS providers could grant access to premium assets, resources and services to malicious entities once they impersonate the geolocation or ID of legitimate users or devices; and this may eventually compromise the complete network system of an organization. The method described in “Secure Hardware Enclave System and Method for Geolocation Computation Using LEO Satellite Assistance”, that is a co-pending U.S. patent application 63/322,760 (which is incorporated herein by reference) proposes a novel system and method to compute the true geolocation of a UE by using a secure positioning enclave that provides no write hooks to firmware. Now, we disclose novel location-based access control systems and methods, using novel immutable factors, that would make it significantly difficult for malicious entities to remotely compromise digital or physical assets of organizations like they did successfully with Colonial Pipeline, Microsoft Exchange, Kaseya in 2021 etc.

### SUMMARY

Novel location-based systems and methods are disclosed that identify, authenticate, and authorize a UE, using one of the two novel immutable factors, and then grant it a privileged access to the premium resources and services of an organization or service provider. The immutable factor either includes of a public device ID and its true geolocation or a secret device ID (SDID) and its true geolocation. The SDID is stored on the write-once hardware chip of a UE at the time of its manufacturing or commissioning, while its true geolocation coordinates are computed according to the exemplary embodiment by a Position Computation Entity (PCE) using LEO satellite assistance as disclosed in the co-pending U.S. patent applications 63/322,760, titled “Secure Hardware System Enclave and Method for Geolocation Computation Using LEO Satellite Assistance” and 63/266,487, titled “Secure Location of Wireless Devices Using LEO Satellite Assistance”, the disclosures of which are incorporated herein by reference.

In an exemplary embodiment of this disclosed concept, an access control engine of a location-based service (LBS) provider stores the preauthorized geolocation coordinates, from where a UE can request a privileged or normal access to resources/services, along with the associated public IDs (MAC address or any other unique device identifier that is known to the ones skilled in the art) in a credential database. In one embodiment, Access control engine may also store login credentials of the user of a requesting UE such as username and password/biometrics. A UE requesting access to resources/services sends a resource/services access request, containing its PublicID_{UE}, login credentials and resource/service ID to access control engine through a non-terrestrial communication network. However, before transmitting resource access request, the communication network is required to verify the immutable factor of LBS provider by computing geolocation of LBS provider and comparing it with the publicly known geolocation of LBS provider that is linked with its public ID. If the login credentials transmitted by the requesting UE match with the stored login credentials in credential database, then access control engine requests non-terrestrial communication network to compute and transmit true geolocation coordinates of the UE. Access control engine compares preauthorized geolocation of the UE that is stored in the credential database with the one it has received from the LEO satellite network and only grants access to the resources/services if the geolocation coordinates are verified. Thus, the UE can have access to the resources/services only after verification of the immutable factor. In scenarios, where a malicious entity has stolen login credentials of a legitimate user by hacking the credential database and is attempting to gain access using the stolen login credentials, the decision to grant or deny access depends on the computed geolocation of the malicious entity and how far away the entity is from one of the stored preauthorized geolocations of the UE of the legitimate user. The geolocation computation method employed in the disclosed concept has an error and, due to this inherent uncertainty, LBS provider might grant access to malicious entities. The error radius, in the presence of malicious UEs, may vary from few thousand of kilometers if the method of co-pending patent application “Secure Location of Wireless Devices Using LEO Satellite Assistance” is used to a few hundred of meters if the method of co-pending patent application “A System and Method to Detect Fake Geolocation Coordinates of a User Equipment by using a Positioning Comparator” is used to only few centimeters if the method of co-pending patent application “A Secure Hardware System and Method for Geolocation Computation” is used.

To address scenarios where it is desirable to minimize an incorrect access control decision, caused by the uncertainty in the geolocation computation method, in one embodiment a stricter LBAC system and method consisting of the immutable factor of SDID and the true geolocation may be used. In this system, a certifying authority (CA) or a plurality of CAs store the SDIDs of all UEs along with their associated public IDs in an SDID database of the CA. The immutable factor of LBS provider has to be validated by the CA and communication network before resource access request is transmitted to access control engine. Access control engine transmits PublicID_{UE} and SDID_{UE} to communication network which in turn forwards the tuple to a CA. The CA authenticates the LBS provider by comparing PublicID_{UE} transmitted by LBS provider with the PublicID_{UE} retrieved corresponding to the SDID_{UE}. If the CA authenticates an LBS provider's SDID_{UE} then the non-terrestrial communication network verifies geolocation of LBS provider in the manner described above. Similarly, access control engine of LBS provider validates the immutable factor of the requesting UE with the assistance of the CA and non-terrestrial communication network after verifying the login credentials of the user of the requesting UE.

One example application for the disclosed concept is authenticated secure banking transactions where transaction requests are processed by the banking server if and only if it can verify and validate the immutable factor of the UE from which a user is requesting the transaction. Another example application for the disclosed concept is in drone delivery systems where drones request geolocation coordinates of the destination from an authenticated drone command center.

### BRIEF DESCRIPTION OF THE DRAWINGS

The accompanying drawings, which are incorporated in and constitute part of this specification, illustrate embodiments of the invention and, together with the description, serve to explain the principles of the invention. The embodiments herein illustrate the invention for NTN composed of LEDs. However, it can be adapted to other NTNs such as those using unmanned aircraft systems (UAS) or high-altitude platforms (HAPs). Furthermore, the embodiments illustrated herein are presently preferred, it being understood by those skilled in the art, however, the invention itself is not limited to the precise arrangements and instrumentalities shown, wherein:

FIG. 1 describes the block diagram of an LBAC system where access to privileged resources is granted using the immutable factor consisting of public ID and the geolocation coordinates of a UE;

FIG. 2 illustrates the entities that comprise trusted network which include serving CMS and other CMSs;

FIG. 3 describes the entities that comprise LBS provider which implements an access control mechanism based on the immutable factor of public ID and geolocation of a UE;

FIG. 4 is the flow graph of the system of FIG. 1 that illustrates the 5 major steps for an ease in enablement;

FIG. 5 is a protocol ladder diagram illustrating protection against attacks that can be launched against the system of FIG. 1 by stealing the credentials (e.g., the tuple <PublicID_{UE}, LoginCredentials_{User}, Resource ID or Service ID>) of a legitimate user;

FIG. 6 describes the block diagram of an LBAC system where access to privileged resources is granted using the immutable factor consisting of SDID and the geolocation coordinates of a UE;

FIG. 7 illustrates the entities that comprise trusted network which include serving CMS, other CMSs, and authentication system;

FIG. 8 is a flow graph of the system of FIG. 6 that illustrates the 6 major steps for an ease in enablement;

FIG. 9 is a protocol ladder diagram illustrating SDID authentication of UE of a legitimate user and the LBS provider;

FIG. 10 is a protocol ladder diagram illustrating protection using immutable factor comprising of SDID and geolocation against attacks that are launched by stealing login credentials of a UE of the legitimate user;

FIG. 11 describes an application scenario in which access to premium or mission critical resources is granted to authenticated senior executives (or officers) from a preauthorized geolocation using authorized devices only;

FIG. 12 illustrates a networked system of entities involved in an e-commerce or banking transaction applications using the immutable factor consisting of SDID and geolocation of UE of legitimate customer;

FIG. 13 illustrates an application scenario for drone delivery systems by using aspects of the disclosed concept; and

FIG. 14 illustrates the protocol ladder diagram for a drone delivery system by utilizing the aspects of the disclosed concept and associated exemplary messages exchanged between the entities involved in the system.

### DETAILED DESCRIPTION

The figures and their corresponding embodiments provided in this disclosure are aspects of the present disclosed concept, and their advantages may be understood by referring to the figures and the following description. The descriptions and features disclosed herein can be applied to a novel and secure access control system in NTNs deployed using LEDs; however, it can be adapted to other NTNs such as those using UAS or HAPs. Henceforth, the figures and embodiments depicted are for the sole purpose of clarity and by any means do not limit the scope of the disclosed concept.

In addition, the following abbreviations shall have the following meanings as used herein: LEO—Low earth orbiting; NTN—Non-terrestrial network; UE—User equipment; 3GPP—Third-generation partnership project; GPS—Global positioning system; GNSS—Global navigation satellite system; LBS—Location-based service; SDID—Secret device ID; LBAC—Location-based access control; UAS—Unmanned aircraft system; HAP—High altitude platform; ToF—Time of flight.

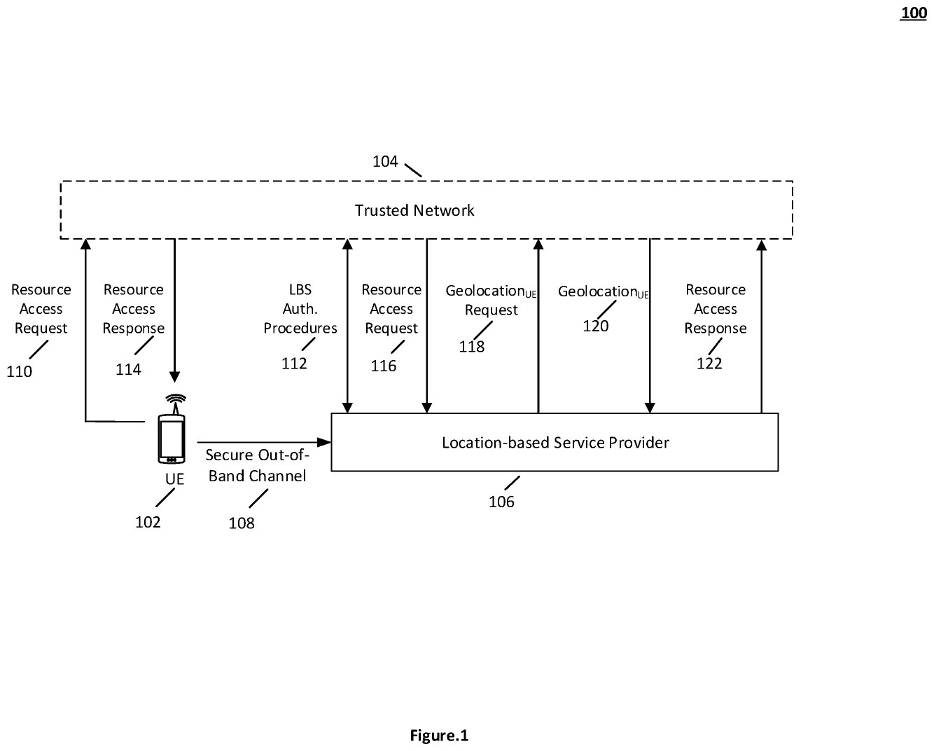

FIG. 1 describes the block diagram of a location-based access control (LBAC) system where access to privileged resources is granted using the immutable factor that is a tuple created by combining public ID with the geolocation coordinates of a user equipment (UE). The communication among all system entities is realized using a non-terrestrial trusted network of satellites. The system of FIG. 1 is comprised of the following entities: UE 102 that requires access to resources; trusted network 104 that facilitates communication and executes authentication and geolocation computation procedures; and location-based service (LBS) provider 106. It is assumed that the system administrator of LBS provider 106 has stored preauthorized secure geolocations corresponding to the PublicID_{UE} of UEs using a secure out-of-band channel 108. Both the preauthorized and currently computed geolocations that are used to authenticate a UE may comprise of an error radius that is dependent on the inherent error of the geolocation computation method. This area, bounded by the radius, is termed as geolocation error bound henceforth. Login credentials, referred to herein as LoginCredentials_{User}, such as username and password or biometrics as required by current LBAC systems, may also be registered with LBS provider 106.

In FIG. 1, when UE 102 desires to access to a resource or service, UE 102 transmits resource access request 110 consisting of a tuple <PublicID_{UE}, LoginCredentials_{User}, ResourceID or ServiceID> to trusted network 104. ResourceID or ServiceID indicates the resources/services that the user of UE 102 is requesting to access. To ensure that the resource access request 110 is transmitted to a legitimate LBS provider 106, trusted network 104 is required to verify the immutable factor comprised of public ID and geolocation coordinates of LBS provider 106. One or a portion of the satellites in trusted network 104 have stored the geolocations of legitimate LBS provider 106. In another embodiment, this information is publicly available and can be accessed by either UE 102 or the satellites of trusted network 104. Before forwarding resource access request 110 to LBS provider 106, trusted network 104 computes geolocation of LBS provider 106 and verifies that the current geolocation of LBS provider 106 matches the pre-authorized geolocation of LBS provider 106 corresponding to its public ID in LBS authentication procedures 112. If trusted network 104 cannot verify immutable factor of LBS provider 106, then communication between UE 102 and LBS provider 106 is terminated and resource access request 110 is not transmitted to LBS provider 106. If trusted network 104 successfully authenticates LBS provider 106 using its immutable factor, trusted network 106 transmits the resource access request 110 to LBS provider 106. After receiving resource access request 116 from trusted network 104, LBS provider 106 verifies that the login credentials of the user of UE 102 are correct and the user is requesting access to the designated resources/services from a pre-registered UE 102. Resource access request 110 is the same as resource access request 110 but labeled differently to indicate that request 110 propagated through the satellites of trusted network 104. Access of the privileged resources is denied to the user of UE 102 if LBS provider 106 determines that some or all of the login credentials in resource access request 116 are incorrect. In the case of successful verification of login credentials, LBS provider 106 issues geolocation_{UE} request 118 to trusted network 104. The satellites of trusted network 104 compute geolocation of UE 102 as disclosed in co-pending U.S. patent application 63/266,487 (incorporated herein by reference), titled “Secure Location of Wireless Devices Using LEO Satellite Assistance” and transmit Geolocation_{UE} 120 to LBS provider 106. LBS provider retrieves preauthorized secure geolocations against PublicID_{UE} of UE 102 and determines if the computed Geolocation_{UE} 120 is within the geolocation error bounds for one of the retrieved geolocations. The radius of geolocation error bound is determined based on the method used for geolocation computation. If UE 102 is within the geolocation error bounds then the immutable factor <PublicID_{UE}, Geolocation_{UE}> of UE 102 is verified and validated and successful resource access response 122 is transmitted from LBS provider 106 to trusted network 104. Trusted network forwards resource access response 114 which is identical to response 122 to UE 102. If UE 102 is outside of the geolocation error bounds, resource access request 116 is denied by LBS provider 106 in resource access response 122.

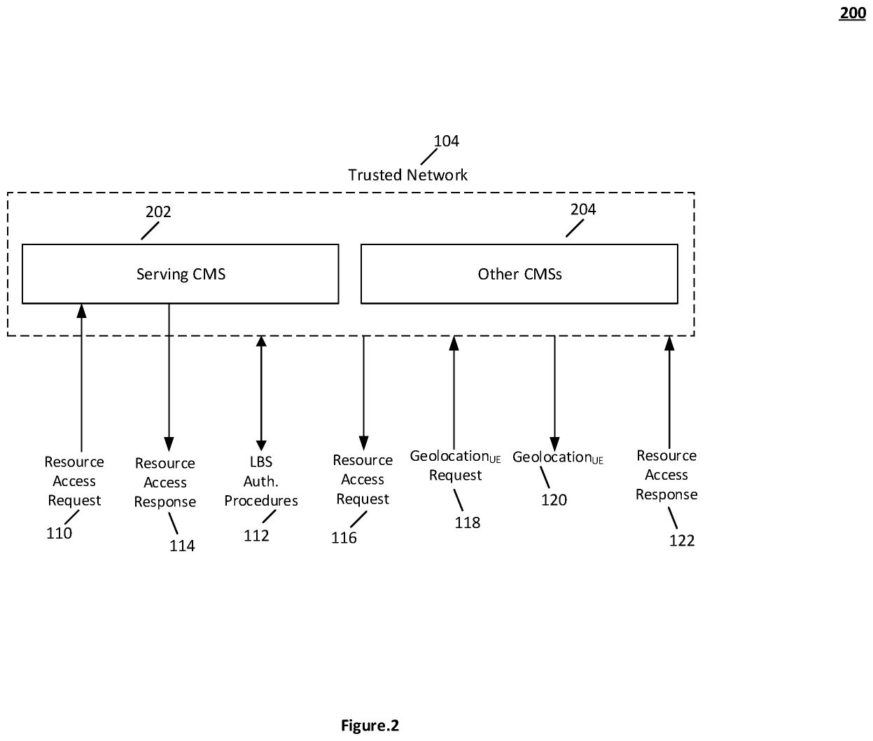

FIG. 2 illustrates the entities that comprise trusted network 104 which include serving CMS 202 and other CMSs 204. Serving CMS 202 that is within the coverage area of UE 102 receives resource access request 110 from UE 102. Serving CMS 202 and other CMSs 204 execute geolocation computation methods disclosed in co-pending U.S. patent application 63/266,487, titled “Secure Location of Wireless Devices Using LEO Satellite Assistance” to compute geolocation of LBS provider 106 to verify its immutable factor. After serving CMS 202 and other CMSs 204 verify the immutable factor of LBS provider 106, resource access request 116 is forwarded to LBS provider 106. Upon reception of geolocation_{UE} request 118 transmitted by LBS provider 106, serving CMS 202 and other CMSs 204 compute geolocation_{UE} 120. The CMS in the coverage area of LBS provider 106 sends current geolocation_{UE} 120 to LBS provider 106. Resource access response 122 is transmitted to either serving CMS 202 or one of the CMS in other CMSs 204. The CMS which receives resource access response 122 forwards it to UE 102 as message 114.

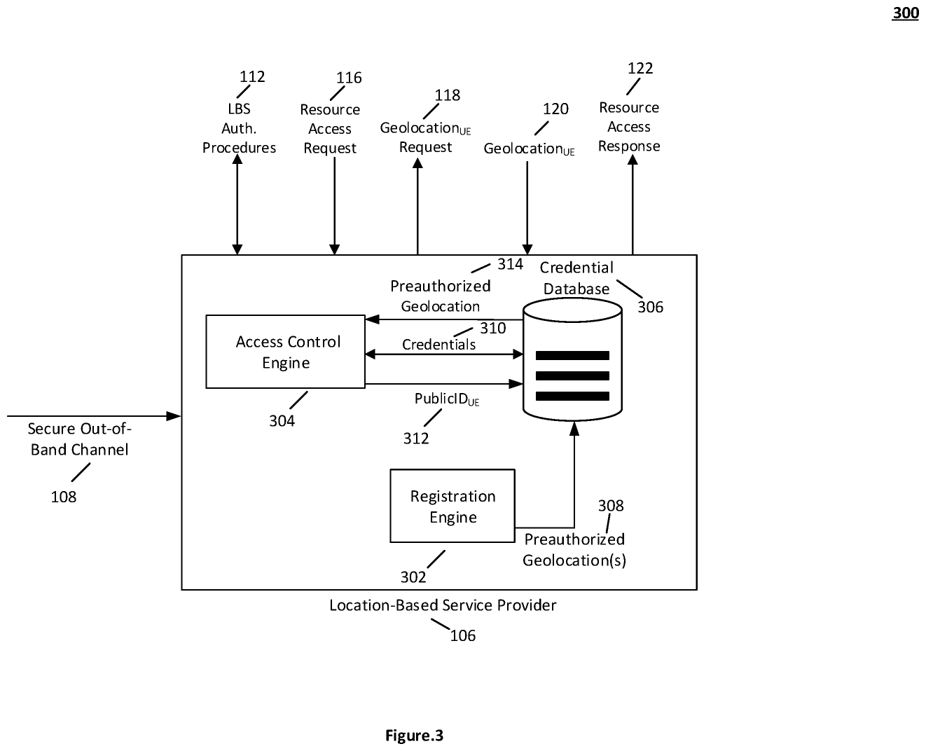

FIG. 3 describes the entities that comprise LBS provider 106 which implements an access control mechanism based on the immutable factor comprising public ID and geolocation of a UE 102. LBS provider 106 is comprised of access control engine 304 which transmits and receives messages from trusted network 104 and executes access control decisions, registration engine 302 through which pre-authorized geolocation(s) 308 of UE 102 are registered with LBS provider 106, and credentials database 306 where pre-authorized geolocations(s) 308 and credentials 310, which consist of the tuple <PublicID_{UE}, LoginCredentials_{User}, ResourceID or ServiceID>, are stored. Access control engine 304 and registration engine 302 may be implemented as part of any suitable computer device including a controller comprising a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. Access control engine 304 performs LBS authentication procedures 112 using its immutable factor with the satellites in trusted network 104 before receiving resource access request 116. When resource access request 116 is forwarded to access control engine 304 in LBS provider 106 by trusted network 104, access control engine retrieves credentials 310 against PublicID_{UE} 312 from credentials database 306 and checks if credentials 310 are the same as contained in resource access request 116. If access control engine 304 is able to verify the credentials of the user of UE 102, then access control engine 304 requests trusted network 104 to compute the geolocation of UE 102 through geolocation request_{UE} 118. Upon reception of geolocation_{UE} 120, access control engine verifies that UE 102 is within the geolocation error bounds of one of the retrieved pre-authorized geolocations(s) 314. Access control engine 304 accepts or rejects resource access request 116 in resource access response 122 based on the authentication status of the immutable factor of UE 102.

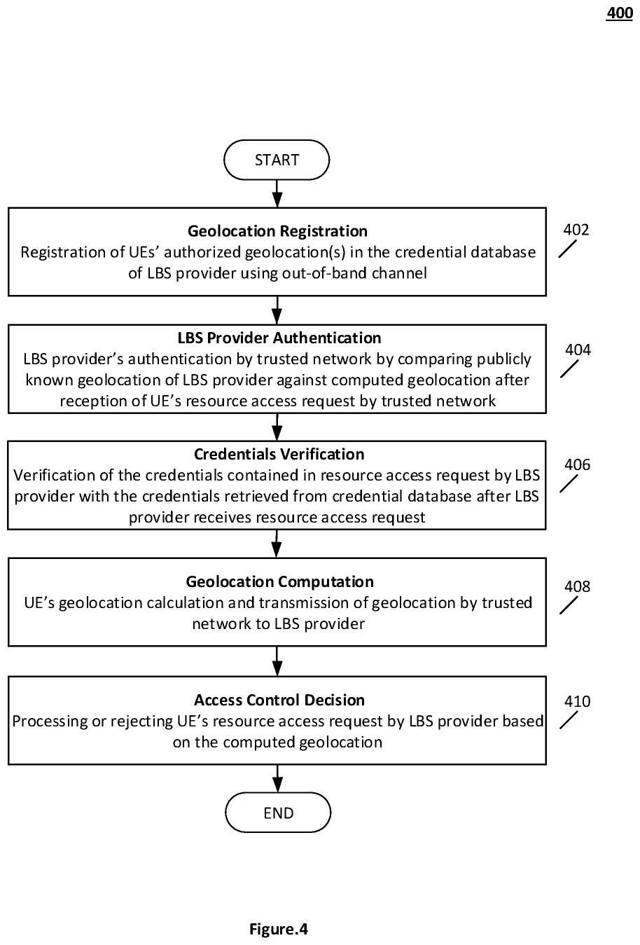

FIG. 4 is a flow graph of the system of FIG. 1 that illustrates the primary major steps. In step 402, labeled “Geolocation Registration”, authorized secure geolocations 308 of UE 102 are registered with LBS provider 106 through secure out-of-band channel 108. In step 404, labeled “LBS provider authentication”, trusted network 104 authenticates LBS provider 106 by verifying geolocation of LBS provider 106. In step 406, labeled “Credentials Verification”, LBS provider 106 retrieves credentials 310 from credential database 308 and matches credentials 310 with the credentials contained in resource access request 116. If the credentials match, then in step 408 labeled “Geolocation Computation”, serving CMS 202, or some other designated computational entity, computes the geolocation of UE 102 and sends the geolocation to LBS provider 106. In step 410, labeled “Access Control Decision”, LBS provider 106 decides whether to accept or deny the request of UE 102 depending on the verification status of its immutable factor.

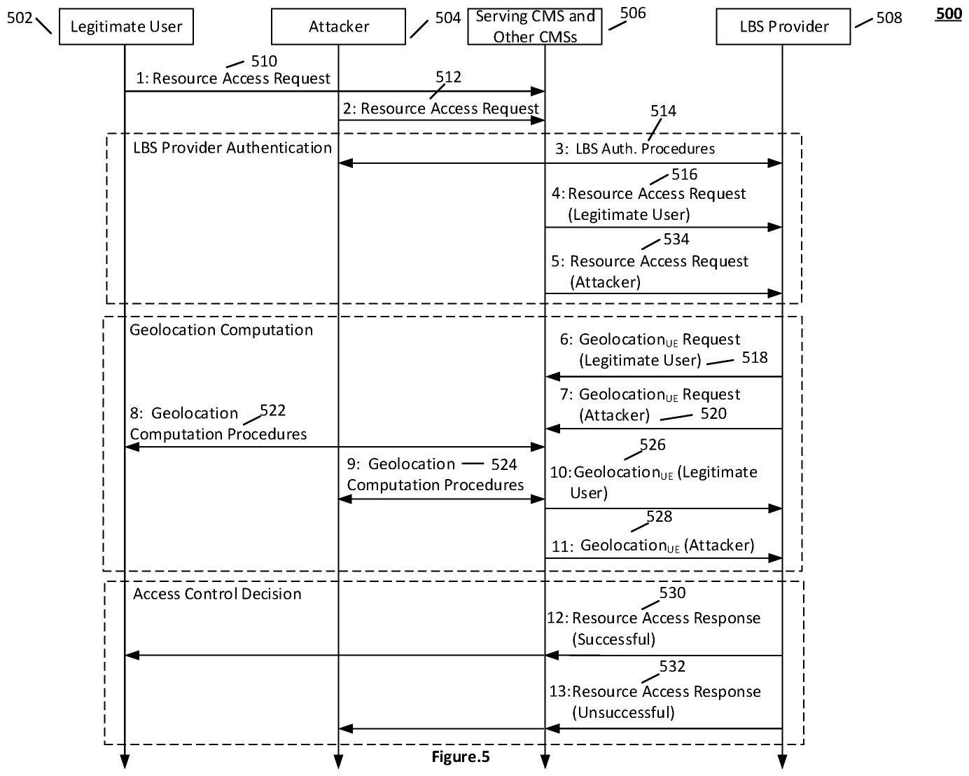

FIG. 5 is a protocol ladder diagram illustrating protection against attacks that can be launched by stealing the credentials (e.g., the tuple <PublicID_{UE}, LoginCredentials_{User}, Resource ID or Service ID>) of legitimate user 502. In ladder diagram 500, UE of legitimate user 502 sends resource access requests 510 to serving CMS and other CMSs 506 in step 1. Similarly, in step 2, UE of attacker 504 sends resource access request 512 to serving CMS and other CMSs 506. Resource access request 512 transmitted by imposter UE of attacker 504 contains credentials 310 of authenticated UE 102 of legitimate user 502. In step 3, serving CMS and other CMSs 506 execute LBS authentication procedures 112 with LBS provider 508. After successful LBS authentication, serving CMS and other CMSs 506 transmit resource access request 510 from legitimate user to LBS provider 508 in step 4. Similarly in step 5, serving CMS and other CMSs 506 forward resource access request 534 to LBS provider 508. Since the credentials in resource access requests 510 and 512 match the credentials 310 retrieved from credentials database 306, LBS provider 508 will transmit geolocation_{UE} request 518 in step 6 to serving CMS and other CMSs 506. LBS provider 508 will also transmit geolocation request_{UE} 520 to serving CMS and other CMSs in step 7. Authenticated UE 102 of legitimate user 502 and UE of attacker 504 will follow geolocation computation procedures 522 and 524 as explained in co-pending U.S. patent 63/343,785 (incorporated herein by reference) “A System and Method to Detect Fake Geolocation Coordinates of a User Equipment by using a Positioning Comparator” respectively in step 8 and step 9. In step 10, serving CMS and other CMSs 506 transmit current geolocation 526 of authenticated UE 102 of legitimate user 502 to LBS provider 508. In step 11, serving CMS and other CMSs 506 transmit current geolocation 528 of imposter UE of attacker 504 to LBS provider 508. Since, legitimate user 502 is requesting access from one of the pre-authorized geolocations 308 stored in credential database 306 of LBS provider 508, its immutable factor will be validated and access will be granted to legitimate user 502 in resource access response 530 in step 12. However, in step 13, resource access request 512 of attacker 504 will be denied in resource request response 532 since attacker 504 is not requesting access from one of the pre-authorized geolocations of legitimate user 502. It is important to emphasize that all steps illustrated in FIG. 5 are performed separately for every resource access request transmitted by a UE.

In an aspect of the disclosed concept where the UEs are not equipped with the Secure Positioning Enclave (SPE) module described in the co-pending U.S. patent application 63/322,760, titled “Secure Hardware Enclave System and Method for Geolocation Computation Using LEO Satellite Assistance”, authentication based on the immutable factor <PublicID_{UE}, Geolocation_{UE}> can also be used to prevent malicious attacks that can be launched in banking or e-commerce applications. Generally, in banking or e-commerce application servers do not limit their service users to carry out transactions from pre-authorized geolocations. Therefore, authentication based on the immutable factor <PublicID_{UE}, Geolocation_{UE}> cannot be used to authenticate transactions completely. However, if an attacker 504 steals the login credentials of legitimate user 502 and the PublicID_{UE} and transmits a transaction request in resource access request 512 to LBS provider 508, which is a banking server in this scenario, close in time to when the transaction request in resource access request 510 of legitimate user 502 is also transmitted to LBS provider 508; the LBS provider may flag these requests as suspicious. The LBS provider 508 can identify that two requests 510 and 512 having the same credentials and PublicID_{UE} but are originating from different geolocations that is impossible for a user to travel, for example one from South Africa and one from LA. The protocol may use method described in FIG. 5. Thus, LBS provider 508, which is a banking server in this scenario, can prevent the malicious transactions using the immutable factor<PublicID_{UE}, Geolocation_{UE}> even in the UEs that do not have a SPE.

Different types of LBS providers may implement different access control mechanisms based on the type of resource/service provided and security levels, among other factors. For instance, for ride-sharing service providers, determining the true geolocation of a user availing the service is more critical than meticulously verifying user and device identity. In the case of financial services, such as stock trading mobile applications, it is imperative to implement strict user and device identity verification measures due to regulatory requirements; while the geolocation of a user may be used as a second form of authentication for large money transactions. Corporations wishing to minimize unauthorized access to mission-critical resources may require both user and device authentication and also geolocation verification. This ensures that only authorized personnel using authenticated device(s) can access company resources from pre-registered geolocations.

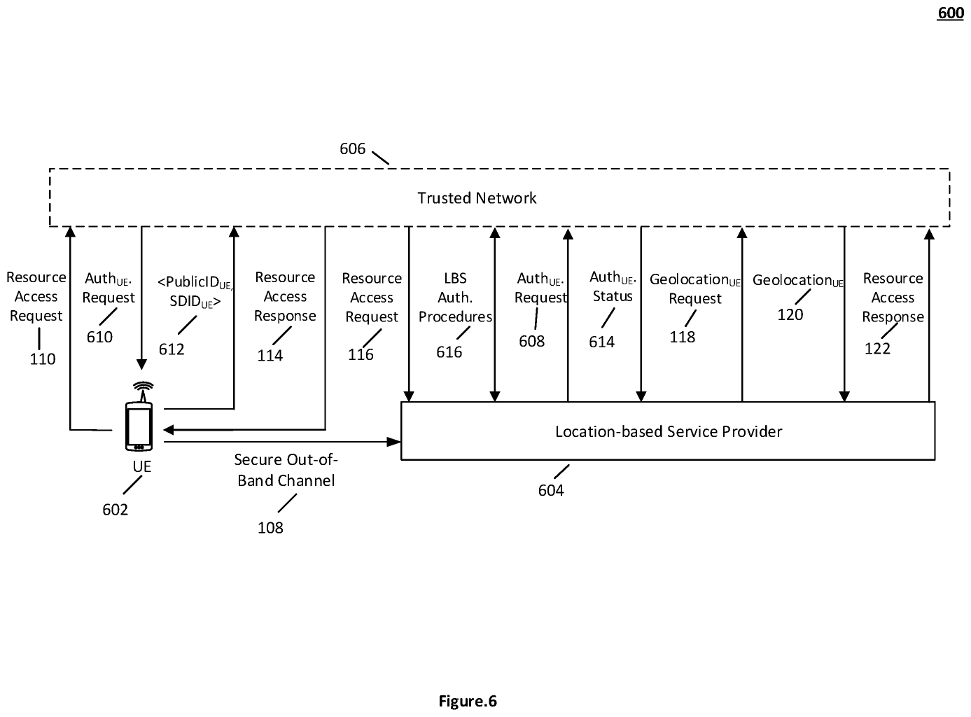

FIG. 6 describes the block diagram of an LBAC system where access to privileged resources is granted using the immutable factor that is created by combining SDID with the geolocation coordinates of a UE. In one embodiment of FIG. 6, LBS provider 604 has implemented a different authentication factor for access control mechanism than the one implemented by LBS provider 106 illustrated in FIG. 1. In the current embodiment, LBS provider 604 requires geolocation verification as well as SDID authentication of UE 602. As illustrated in co-pending U.S. patent application 63/322,760, titled “Secure Hardware Enclave System and Method for Geolocation Computation Using LEO Satellite Assistance”, SDID of a UE 602 is a unique and unclonable identifier that is stored on the hardware chip of UE 602. Under the system of FIG. 6, resource access requests 110 of only those UEs 602 are processed by LBS provider 604 that have secure positioning enclave and also a SDID that is hardwired on the chip.

In one embodiment illustrated in FIG. 6, UE 602 transmits resource access request 110 to trusted network 606. Satellites in the trusted network 606 receive resource access request 110 from UE 602 and execute LBS authentication procedures 616 with LBS provider 604 before transmitting resource access request 110 of UE 602 to it. In LBS authentication procedures 616, LBS provider 604 is required to provide the encrypted tuple <PublicID_{LBS}, SDID_{LBS}> to trusted network 606 for its authentication which ensures that a malicious entity is not masquerading as LBS provider 604 using PublicID_{LBS}. If trusted network 606 is unable to authenticate LBS provider 604 using <PublicID_{LBS}, SDID_{LBS}> then communication between UE 602 and LBS provider 604 is terminated. In case of a successful authentication using tuple <PublicID_{LBS}, SDID_{LBS}>, trusted network 606 verifies geolocation of LBS provider 604 as described in FIG. 1. Once trusted network 606 successfully validates the immutable factor of LBS provider 604 comprised of SDID and geolocation, trusted network 606 transmits resource access request 116 to LBS provider 604.

LBS provider 604 verifies the credentials contained in resource access request 116 of UE and transmits authentication_{UE} request 608 to trusted network 606. Authentication_{UE} request 608 requires UE 110 to authenticate itself with the trusted network 606 using tuple <PublicID_{UE}, SDID_{UE}> 612. Trusted network 606 forwards request 608 to UE 602 in Authentication_{UE} request 610. UE 602 transmits encrypted tuple <PublicID_{UE}, SDID_{UE}> 612 to trusted network 606 in response to Authentication_{UE} request 610. Trusted network 606 executes authentication procedures illustrated in Figure and sends Authentication_{UE} status 614 to LBS provider 604. If UE 102 is successfully authenticated then LBS provider 604 repeats the geolocation verification procedure described in FIG. 1. Based on the verification status, LBS provider 604 grants or denies resource access request 116 by sending resource access response 122 to trusted network 606 which forwards relevant portions to UE 602 through resource access response 114.

In another embodiment of the disclosed concept, UE 102 sends SDID_{UE} in resource access request 110 to trusted network 606. One of the satellites in trusted network 606 extracts SDID_{UE} and verifies it before forwarding resource access request 116 to LBS provider 604. In such embodiment, if the trusted network 606 is unable to authenticate UE 102 using its SDID, its resource access request 110 is not transmitted to LBS provider 604 and the connection is not established between UE 102 and LBS provider 602.

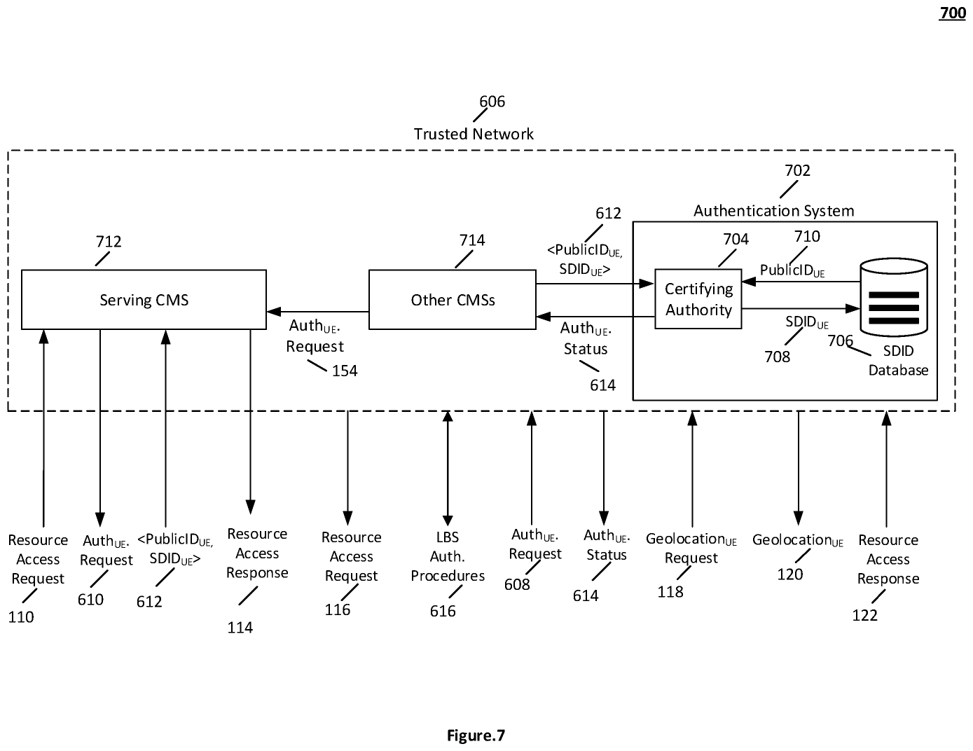

FIG. 7 is the block diagram of the entities that comprise trusted network 606 which include serving CMS 712, other CMSs 714, and authentication system 702. In this embodiment, one or more of the satellites in trusted network 606 have significant computing power and storage space to house authentication system 702 consisting of certifying authority 704 and SDID database 706. Certifying authority 704 may be implemented as part of any suitable computer device including a controller comprising a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. It is important to note that trusted network 606 can service both embodiments of LBS provider 106 and 604. LBS provider 106 uses credentials in resource access request 116 and computed geolocation_{UE} 120 to grant or deny access while LBS provider 604 also requires trusted network 606 to authenticate UE 602 using its SDID before processing resource access request 116.

Authentication system 702 is required to authenticate LBS provider 604 before serving CMS 712 or one of the other CMSs 714 forwards resource access request 116 to LBS provider 604. Certifying authority 704 receives the encrypted tuple <PublicID_{LBS}, SDID_{LBS}>, directly or indirectly, from the CMS that is serving LBS provider 604. Certifying authority 704 retrieves PublicID_{LBS} corresponding to the received SDID_{LBS} from SDID database and compares retrieved PublicID_{LBS} with the transmitted PublicID_{LBS}. If the retrieved PublicID_{LBS} and transmitted PublicID_{LBS} match, then serving CMS 712 and other CMSs 714 verify geolocation of LBS provider 604 by comparing the computed current geolocation of LBS provider 604 with the preauthorized geolocation of LBS provider stored in the database of the trusted network 606. In the case of successful authentication of the immutable factor <SDID_{LBS}, Geolocation_{LBS}> of LBS provider 604, resource access request 116 is forwarded to LBS provider 604. If LBS provider 604 requires SDID authentication of UE 602 then authentication request_{UE} 608 is routed by serving CMS 712 and other CMSs 714 through the satellite network and is received by UE 602 in 610. Serving CMS 712 receives the encrypted tuple <PublicID_{UE}, SDID_{UE}> 612 from UE 602 and forwards the tuple 612 to the satellite housed authentication system 702 either directly or indirectly depending on the position of the satellite. Certifying authority 704 searches for PublicID_{UE} 710 corresponding to received SDID_{UE} 708 in SDID database 706. If PublicID_{UE} 710 retrieved from the SDID database 706 is the same as received in the tuple 612, then successful authentication status_{UE} 614 is sent to the CMS serving LBS provider 604.

If the satellites do not have sufficient computing power and storage space to execute the methods required to authenticate a UE, then the authentication task is accomplished by a separate, terrestrial authentication system which together with satellites 712 and 714 comprise trusted network 606. At least serving CMS 712 or one of the CMSs in other CMSs 714 is responsible for interacting with ground-based authentication system. In an embodiment where serving CMS 712 is not in the coverage area of the authentication system, that responsibility falls to one of the other CMSs 714. The CMS responsible for interacting with the terrestrial authentication system (either serving CMS 712 or one from among other CMSs 714) sends the tuple 612 to ground-based certifying authority in the authentication system.

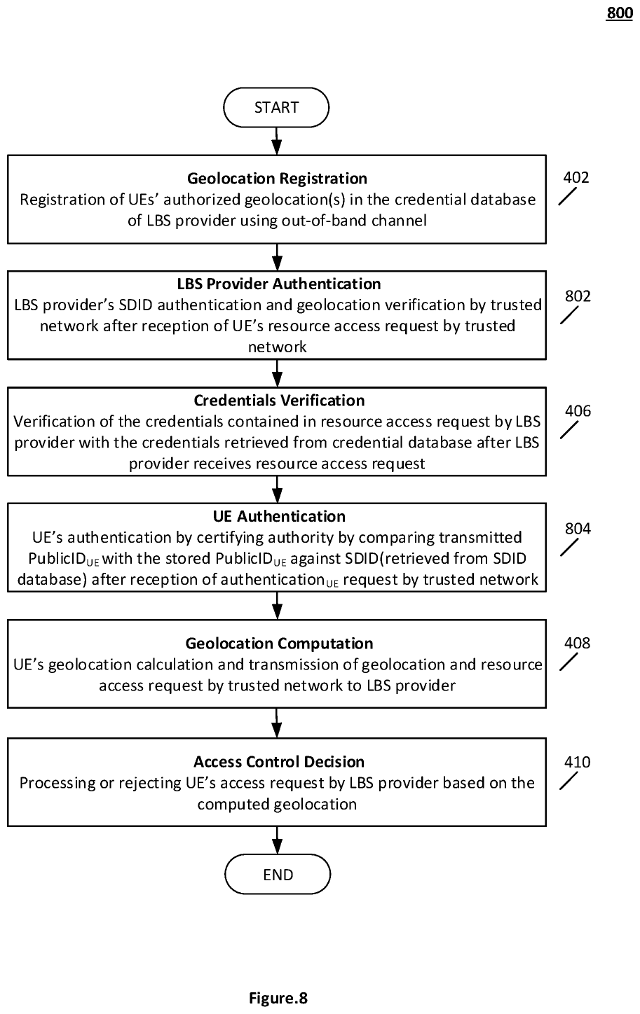

FIG. 8 is a flow graph of the system of FIG. 6 that illustrates the 6 major steps for an ease of enablement. Steps 402, 406, 408, and 410 are the same steps as those illustrated in FIG. 4. In a new step 802, called “LBS Provider Authentication”, trusted network 606 verifies the immutable factor <SDID_{LBS}, Geolocation_{LBS}> of LBS provider 604 by searching in SDID database 706 the received publicID_{LBS} against its SDID_{LBS} and comparing computed geolocation_{LBS} against publicly known preauthorized geolocation_{LBS}. In step 804, called “UE Authentication”, certifying authority 704 in trusted network 606 searches for PublicID_{UE} 710 against transmitted SDID UE 708. If the retrieved PublicID_{UE} 710 matches with the PublicID_{UE} in the transmitted tuple <PublicID_{UE}, SDID_{UE}> then UE 602 is successfully authenticated.

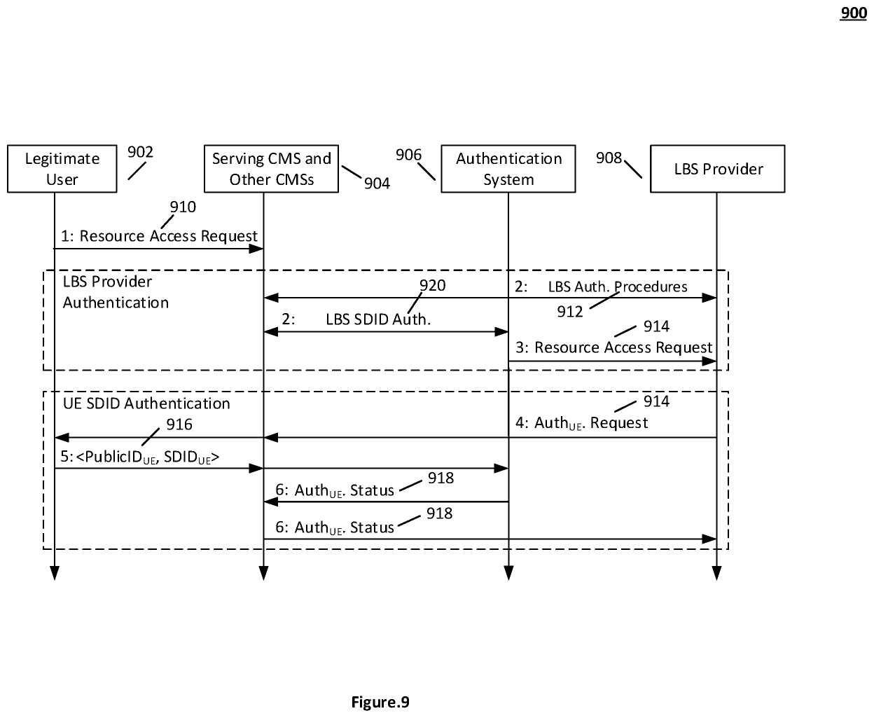

FIG. 9 is a protocol ladder diagram illustrating SDID authentication of UE of legitimate user 902 and LBS provider 908. In step 1, UE 602 of legitimate user 902 transmits resource access request 910 to serving CMS and other CMSs 904 in trusted network 606. Trusted network 606 consisting of serving CMS and other CMSs 904 and authentication system 906 is required to execute LBS authentication procedures 912 including SDID authentication and geolocation verification with LBS provider 908 before transmitting the resource access request 910 to it. Step 2 illustrates authentication of LBS provider 908 performed by serving CMS and other CMSs 904 and authentication system 906. LBS authentication procedures 912 are message exchanges that include the SDID and positioning signals illustrated in co-pending U.S. patent application 63/322,760, titled “Secure Hardware Enclave System and Method for Geolocation Computation Using LEO Satellite Assistance”. Serving CMS or other CMSs 904 verify tuple of <PublicID_{LBS}, SDID_{LBS}> through LBS SDID authentication message exchanges 920 with authentication system 906. Once LBS provider 908 is authenticated, serving CMS and other CMSs 904 forward resource access request 910 to LBS provider 908 in step 3. If LBS provider 908 requires authentication system 906 to authenticate UE 602 of legitimate user 902, then LBS 908 provider sends authentication request_{UE} 914 to serving CMS and other CMSs 904 which in turn forward them to UE 602 of legitimate user 902 in step 4. In step 5, in response to authentication request_{UE} 914, UE 602 of legitimate user 902 transmits tuple <PublicID_{UE}, SDID_{UE}> 916 to authentication system 906 via serving CMS and other CMSs 904. In step 6, authentication system 906 generates authentication status 918 based on tuple 916 which is forwarded to LBS provider 908. Geolocation verification of UE is then carried out on the request of LBS provider 908 as explained earlier.

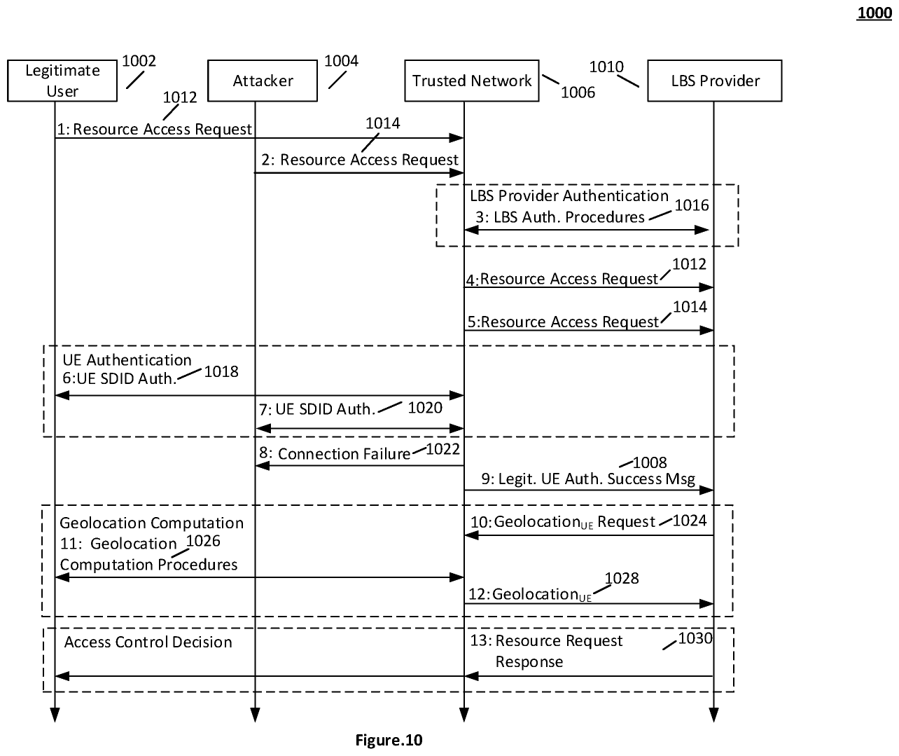

FIG. 10 is a protocol ladder diagram illustrating protection using immutable factor <SDID_{UE}, Geolocation_{UE}> against attacks that are launched by stealing the credentials i.e., the tuple <PublicID_{UE}, LoginCredentials_{User}, Resource ID or Service ID> of an authenticated UE of legitimate user 1002. In such attack scenarios, the resource access request 1014 transmitted by imposter UE of attacker 1004 contains the stolen credentials of the authenticated UE of legitimate user 1002. Authenticated UE of legitimate user 1002 and imposter UE of attacker 1004 transmit resource access requests 1012 and 1014 to CMSs in trusted network 1006 respectively in step 1 and step 2. Once both or one of the requests 1012 and 1014 are received by trusted network 1006, then trusted network 1006 comprised of authentication system and CMSs, execute LBS authentication procedures 1016 with LBS provider 1010 in step 3. LBS provider 1010 receives resource access requests 1012 and 1014 respectively in step 4 and step 5 once authentication system in trusted network 1006 verifies the immutable factor of LBS provider 1010. Since the credentials of legitimate user 1002 match with the credentials retrieved from credential database 306, LBS provider 1010 requests trusted network 1006 to authenticate authentic UE 602. However, attacker 1004 has also transmitted credentials of legitimate user 1002. In order to differentiate the resource access request of legitimate user 1002, LBS provider 1010 requests the authentication of the immutable factor of the requesting UEs from trusted network 1006. Trusted network 1006 carries out authentication procedures of authenticated UE of legitimate user 1002 using messages 1018 and authentication procedures of imposter UE of attacker 1004 using messages 1020 respectively in step 6 and step 7. Since the tuple <PublicID_{UE}, SDID_{UE}> of authenticated UE of legitimate user will be verified and the tuple <PublicID_{UE}, SDID_{UE}> of imposter UE of attacker 1004 will not be verified, therefore, trusted network 1006 transmits the connection failure message 1022 to UE of attacker 1004 in step 8 and authentication successful message 1008 of legitimate user 1002 to LBS provider 1010 in step 9. After authentication of the authenticated UE of legitimate user 1002, LBS provider 1010 requires determining the current geolocation of authenticated UE of legitimate user 1002. In step 10, LBS provider 1010 transmits the geolocation_{UE} request 1024 of legitimate user 1002 to trusted network 1006. Trusted network 1006 will follow geolocation computation procedures 1026 with the UE of legitimate user 1002 in step 11. In step 12, trusted network 1006 will transmit Geolocation_{UE} 1028 to LBS provider 1010. In step 13, LBS provider 1010 accepts or rejects resource access request 1012 of legitimate user 1002. If legitimate user 1002 is within the geolocation error bounds of one of preauthorized geolocations 308 stored in credentials database 306, a successful resource response 1030 will be transmitted to UE 602 of legitimate user 1002. Otherwise, the resource request will be denied on the resource request response 1030.

According to an aspect of the disclosed concept, in scenarios in which a legitimate user 1002 changes his UE 602, it is required to register new UE 602 in credential database 306 of LBS provider 1008 services or resources. Legitimate user 1002 is also required to securely deliver previous UE 602 to the service provider. A userID is stored in the credential database 306 of LBS provider 1008 at the time of registration of UE 602 of legitimate user 1002. A userID can be a biometric or a secureID of user 1002 of a particular UE 602. The userID is required to be verified and transmitted by legitimate user 1002 of LBS provider 1010 whenever legitimate user 1002 changes his UE 602. In cases where legitimate user 1002 possesses multiple UEs, he will have a single userID corresponding to unique immutable factors of each UE 602. The method and procedure to add a UE 602 in the authentication system of LBS provider 1010 or remove a UE 602 from it should be carried out at preauthorized geolocations 308. In another embodiment of the disclosed concept where previous UE 602 is neither damaged nor lost, legitimate user 1002 should register his new UE 602 from already registered UE 602 at a preauthorized geolocation 308. LBS provider 1010 may provide the feature of registering new UEs 602 to legitimate users 1002. Once LBS provider 1010 determines that credentials of legitimate user 1002 are correct and that the legitimate user is adding new UE 602 from authorized UE 602 and from one of preauthorized geolocations 308, LBS 1010 provider links the PublicID_{UE} of new UE 602 with the userID of legitimate user 1002. In cases where previous UE 602 of the user 402 is lost or damaged, legitimate user 1002 of LBS provider 1010 should report its damage or loss and register its new UE 602 using secure out of band channel 108 after verification of its userID.

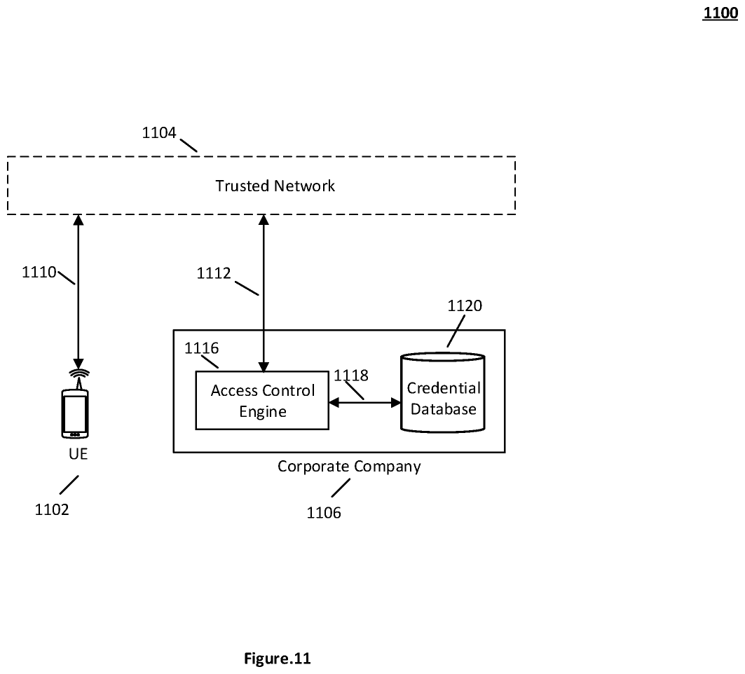

FIG. 11 describes an application scenario in which access to premium or mission critical resources is granted to authenticated senior executives (or officers) from a preauthorized geolocation using authenticated devices only. The LBAC method enhances access control security by using immutable factor <SDID_{UE}, Geolocation_{UE}> of a UE 1102. By authorizing legitimate users to access premium resources using a secure UE from a preauthorized geolocation, the disclosed concept makes it very difficult for malicious entities to impersonate legitimate UEs as they could not generate their immutable factors even if they have hacked personal authentication credentials of legitimate users. If a user works from home or is travelling for work or is transferred to another office, then the user must register these locations as preauthorized geolocations with access control engine 1116 by using secure out-of-band channel 108. Access control engine 1116 stores them in credentials database 1120. UE 1102 transmits resource access request 1012 to corporate company 1106 using communication link 1110 to trusted network 1104. All communication between trusted network 1104 and corporate company 1106 is realized using the communication link 1112. Trusted network 1104 performs LBS provider authentications step 902 and transmits resource access request 1012 to access control engine 1116. Access control engine 1116 verifies credentials of the user of UE 1102 by executing credentials verification step 406. Subsequently, trusted network 1104 performs UE authentication step 904 and geolocation computation step 406 after receiving authentication_{UE} request 1014 and geolocation_{UE} request 1024 from access control engine 1116. After geolocation computation, trusted network 504 transmits Geolocation_{UE} 1028 of UE 1102 to access control engine 1116. Access control engine 1116 retrieves preauthorized geolocation(s) 314 from credential database 1120 using connection 1118. If the computed immutable factor matches with the immutable factor of UE 1102 stored in credential database 1120, then the user of UE 1102 is authorized to access resources or services of corporate company 1106.

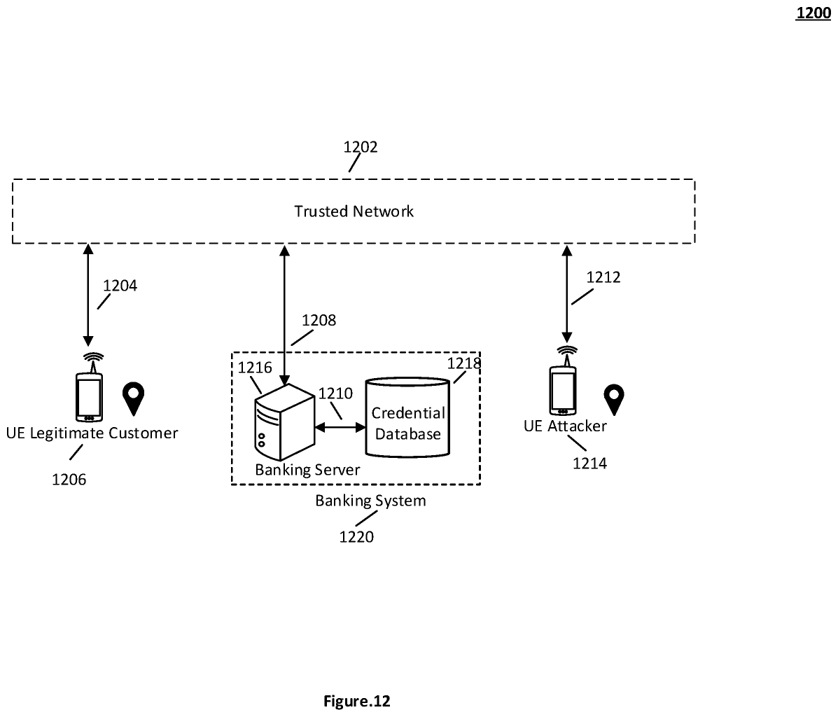

FIG. 12 illustrates a networked system of entities involved in an e-commerce or banking transaction applications using the immutable factor consisting of SDID and geolocation of UE of legitimate customer 1206. A banking server 1216 requires its customers to request transactions through trusted network 1202. In FIG. 12, a legitimate customer is on UE 1206 and an attacker is using UE 1214. The attacker on UE 1214 wants to operate the bank account of the legitimate customer on UE 1206, as the attacker has stolen e-banking credentials of the legitimate customer. The legitimate user on UE 1206 and the attacker on UE 1214 are communicating with the banking server 1216 through channels 1204 and 1212 respectively of the trusted network 1202. Banking system 1220 processes the transaction requests only if trusted network 1202 verifies SDID_{UE} in authentication step 904 and banking server 1216 verifies credentials and current Geolocation_{UE} using credentials verification step 406 and geolocation computation step 408. Since UE 1214 of attacker could not generate the immutable factor of UE 1206, i.e., preauthorized geolocation stored in credential database 1218 connected to banking server 1216 through connection 1210 and SDID_{UE} stored in the SDID database of trusted network 1202, the attacker on UE 1214 could not operate the bank account of the legitimate customer even though the attacker has stolen e-banking credentials of legitimate customer. In comparison, current online banking systems do not provide any security if e-banking credentials of a user are compromised, or the user's mobile device or wallet is hacked.

In one embodiment, banking system 1220 may consider relaxing the requirement of operating a bank account from a preauthorized geolocation only if the amount is less than a threshold value. The method to detect a malicious activity by a hacker in such a scenario is named “fraud detection method”. In fraud detection method, if the UEs of customers of the bank are not equipped with a SPE module, then the authentication can only be based on recent geolocation information. A UE is required to carry out the geolocation computation protocol with the network of CMS s in trusted network 1202 as described in co-pending U.S. patent 63/343,785, titled “A System and Method to Detect Fake Geolocation Coordinates of a User Equipment by using a Positioning Comparator”, at regular time intervals. This will enable to detect any malicious activity in which the public IDs of UEs are compromised and misused. This geolocation information is stored by a Cluster Head Satellite (CHS) or ground based server in a database. In an attack scenario, if an attacker on UE 1214, have acquired login credentials of legitimate user on UE 1206, attempts to launch an attack by masquerading the public ID of UE 1206, banking server 1216 requests trusted network 1202 to determine the recent geolocation information of UE 1206. In an embodiment, the CHS in trusted network 1202 or ground based server retrieves recent geolocation information from the database and forwards it to banking server 1216. Banking server 1216 runs location analytics method on recent geolocation information corresponding to the public ID of UE 1206 to detect any malicious activity. For example, if the differential value of geolocation coordinates indicates that the physical movement of a user violates physics of movements based on high speed vehicles or aircrafts, banking server 1216 will be able to deny such transaction attempts and flag the request as malicious.

In a further scenario, where UE 1206 of the legitimate customer is not following the geolocation computation protocol due to it being powered off or the customer has intentionally disabled the geolocation computation service due to any reason, the legitimate customer becomes susceptible in a vulnerable to malicious attacks. However, for an attacker to launch a successful attack, the attacker should be aware of the recent geolocation coordinates computed by trusted network 1202 before the geolocation computation service has been disabled. Furthermore, an attacker can only launch the attack if difference in the time when the geolocation computation service was disabled and the time when the attack was launched does not violate movement constraints based on highs speed vehicles or aircrafts. If banking server 1216 observes such violations, the transaction request gets denied by flagging them as suspicious.

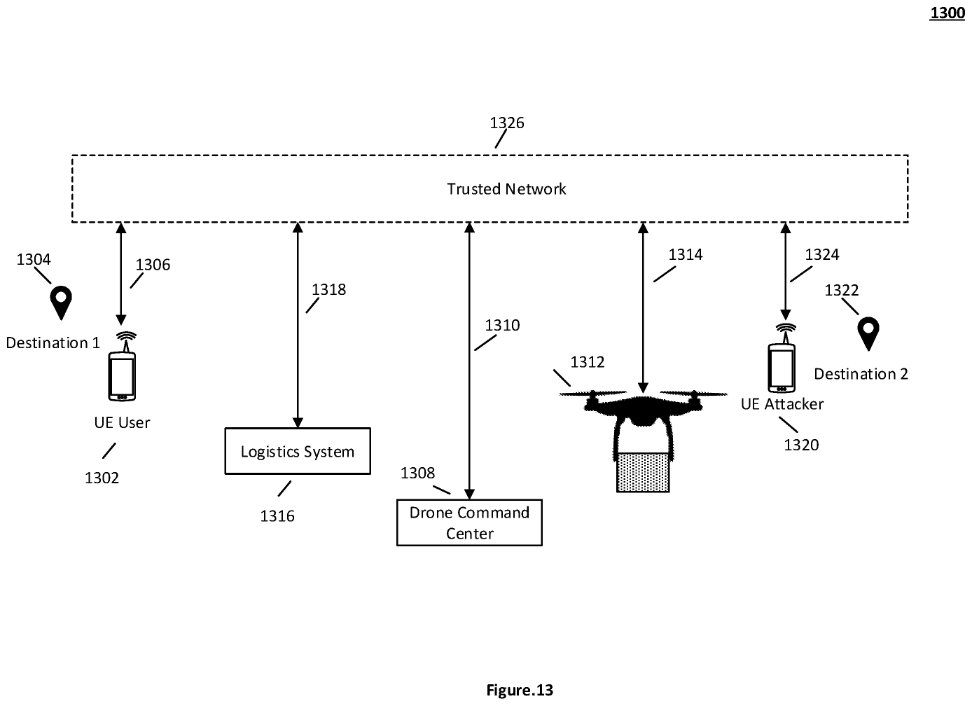

FIG. 13 illustrates an application scenario for drone delivery systems by using aspects of the disclosed concept. Conventionally, signals sent by GPS are used by drones to determine their geolocation. These signals can be jammed and spoofed due to their weak signal strength and one-way, public broadcast nature. Therefore, an attacker could mislead the drones about their geolocation and hence can trick its control system to deliver a package at a false destination. Alternatively, a malicious entity can impersonate as a drone command center, which supplies target geolocations to drones, causing delivery drones to deliver packages to wrong geolocations. The method described in FIG. 9 determines the geolocation coordinates by taking assistance from LEO satellites and therefore in such scenarios, a message that contains the geolocation coordinates computed by trusted network 1326 will eliminate the need to use weak timing signals of GPS.

In the example scenario of FIG. 13, UE 1302 is requesting a package to be delivered at destination 1304 from Logistics system 1316 through resource access request 1012. Logistics system 1316 may be large enough to develop its own drone delivery service or it may collaborate with external partners to offer the delivery service. In resource access request 1012, ServiceID indicates delivery service while additional information contained in request 1012 is target destination 1304. Resource access request may also contain payment details which are needed to place a delivery order. These payment details are forwarded by the logistics systems to the banking server and therefore authentication procedures detailed in FIG. 10 are followed. An important entity in the drone delivery service is drone command center 1308 which is responsible for managing drones including supplying target destinations to drones. Logistics system 1316 communicates remotely with drone command center 1308 through trusted network 1326. Trusted network 1326 authenticates Logistics system 1316 by executing the appropriate authentication procedures described in FIG. 8. Logistics system 1316 extracts destination 1304 from resource access request after steps 406, 408, optional step 804, 408, and 410 have been executed. Once Logistics system 1316 is ready to communicate with drone command center 1308, trusted network 1326 and Logistics system 1316 authenticates drone command center 1308 through the appropriate immutable factor. If the drones, managed by drone command center 1310, cannot be manually inspected onsite then trusted network 1326 is required to authenticate the drones as well before transmitting target destinations to them.

In FIG. 13, UE of user 1302 requests a package to be delivered to destination 1304 through the communication link 1306. Logistics system 1316 receives resource access request 1012 of UE 1302 of user from trusted network 1326 through communication link 1318. Drone command center receives target destination 1304 along with additional information from Logistics system 1318 through trusted network 1326 via communication link 1310. Drone 1312 is required to deliver a package to destination 1304. Currently, an attacker on UE 1320 may spoof the GPS signals received by drones or impersonate drone command center 1308 to misguide drone 1312 using link 1324 to deliver the package at the attacker's preferred destination 1322. To minimize impersonation attacks, drone command center 1308 after being authenticated by trusted network 1326 transmits target destination 1304 to drone 1312 on communication link 1310. Drone 1312 receives target destination 1304 from trusted network 1326 on communication link 1314. While flying on its delivery route, drone 1312 is required to request its current geolocation by performing geolocation computation step 408 with the assistance of trusted network 1326. Trusted network 1326 transmits geolocation to drone 1312. Consequently, drone 1312 will ignore any other signals that are not transmitted by trusted network 1326 and hence will deliver its package to destination 1304.

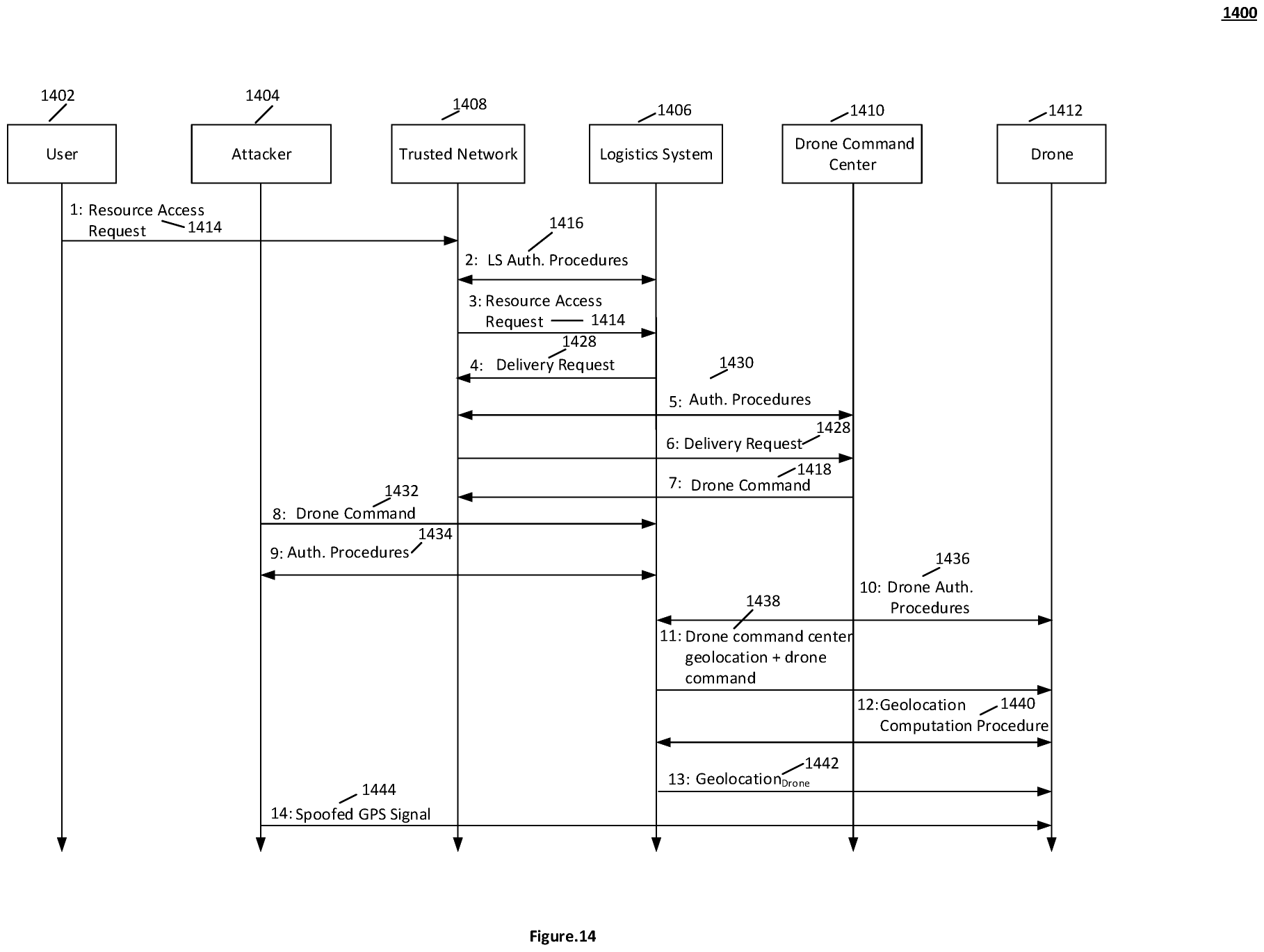

FIG. 14 illustrates the protocol ladder diagram for a drone delivery system by utilizing the aspects of the disclosed concept and associated exemplary messages exchanged between the entities involved in the system. In step 1, UE of user 1402 transmits resource access request 1414 to trusted network 1408. In step 2, trusted network 1408 performs logistic system authentication procedures 1416 and subsequently forwards resource access request 1414 to Logistics system 1406 in step 3. Logistic system 1406 extracts target destination 1304 from resource access request 1414 and transmits delivery request 1428 containing target destination 1304 to trusted network 1408 in step 4. Before transmitting delivery request 1428 to drone command center 1410, trusted network 1408 is required to engage in drone command center authentication procedures 1430 with drone command center 1410 in step 5. Drone command center authentication procedures 1430 may consist of steps 804 and 408 or step 408 only. After authenticating drone command center 1410, trusted network 1408 forwards delivery request 1428 to drone command center 1410 in step 6.

In step 7, drone command center 1410 extracts target destination from delivery request 1428 and sends drone command 1418, which contains destination 1304 and other relevant information, to trusted network 1408. UE of attacker 1404 aiming to impersonate drone command center 1410 sends drone command 1432 which contains a target destination chosen by attacker 1404 in step 8. In step 9, trusted network 1408 performs UE authentication step 804 in fake drone command center authentication procedures 1434. In the case where fake drone command center 1404 is trying to impersonate drone command center 1410, the transmitted immutable factor <SDID_{FAKECENTER}, PublicID_{FAKECENTER}> will not match with the immutable factor <SDID_{COMMANDCENTER}, PublicID_{COMMANDCENTER}> pair of drone command center 1410 so drone command 1432 transmitted by fake drone command center 1404 will not be transmitted to drone 1412. To ensure that drone command center 1410 is actually communicating with one of the drones managed by drone command center 1410, trusted network 1408 performs drone authentication procedures 1436 consisting of SDID authentication with drone 1412 in step 10. In step 11, after successful drone authentication, trusted network 1408 transmits drone command 1418 and geolocation of drone command center 1410 in message 1438 to drone 1412. Drone 1412 has been provided with the geolocation of drone command center 1410 beforehand. Drone 1412 processes drone command 1418 after comparing transmitted geolocation with the stored geolocation and is able to authenticate the drone command center 1410. Furthermore, during the delivery route, drone 1412 executes geolocation computation procedures 1440 with trusted network 1408 in step 12. Subsequently, in step 13, drone 1412 receives its current geolocation in message 1442. In such scenarios, an authenticated message that contains the geolocation information, calculated and signed by the trusted network 1408, will remove the need to use the cryptographically insecure timing signals of GPS. In step 14, attacker 1404, aiming to mislead drone 1412, generates and transmits spoofed GPS signal 1444 to drone 1412. However, drone 1412 will ignore any other signals including the spoofed GPS signals 1444, that are not transmitted by trusted network 1408, and hence will be able to deliver the package to the geolocation of the UE of user 1402.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An immutable factor authentication system for determining whether a user device is authorized to have access to a resource or service of a provider, the user device having a public device ID and a user of the user device having user login credentials, comprising
an access control engine; and
a credential database, wherein the credential database stores a plurality of pre-authorized user device geolocations and a plurality of pre-authorized user credentials, wherein the access control engine is structured and configured to:
(i) receive the public device ID of the user device and the user login credentials of the user;
(ii) determine whether the user login credentials match one of the pre-authorized user credentials;
(iii) if the user login credentials are determined to match one of the pre-authorized user credentials, request and receive a computed geolocation for the user device from a trusted source;
(iv) determine, using the public device ID, whether the computed geolocation matches one of the pre-authorized user device geolocations; and
(v) if the computed geolocation is determined to match one of the pre-authorized user device geolocations, validate that the user device is authorized to have access to the resource or the service of the provider.

2. The system of claim 1, wherein the trusted source is a network comprising a number of satellites.

3. The system of claim 1, further including a registration engine structured and configured to enable users, devices or system administrators to store the plurality of pre-authorized user device geolocations and the plurality of pre-authorized user credentials in the credential database, each of the plurality of pre-authorized user device geolocations and each of the plurality of pre-authorized user credentials being stored in association with a respective public device ID.

4. The system of claim 3, wherein the users, devices or system administrators are able to store the plurality of pre-authorized user device geolocations and the plurality of pre-authorized user credentials in the credential database using an out-of-band secure channel.

5. The system of claim 1, wherein the access control engine is structured and configured to, in response to validating that the user device is authorized to have access to the resource or the service of the provider, generate and transmit a resource access response to the trusted source indicating that access has been authorized.

6. The system of claim 1, wherein the access control engine is structured and configured to determine whether the computed geolocation matches one of the pre-authorized user device geolocations by determining whether the computed geolocation is within predetermined geolocation error bounds of one the pre-authorized user device geolocations.

7. The system of claim 1, wherein the provider is a location based provider and wherein the access control engine and the credential database are part of a computer system of the location based provider.

8. An immutable factor authentication method for determining whether a user device is authorized to have access to a resource or service of a provider, the user device having a public device ID and a user of the user device having user login credentials, the method comprising storing a plurality of pre-authorized user device geolocations and a plurality of pre-authorized user credentials;
receiving the public device ID of the user device and the user login credentials of the user;
determining whether the user login credentials match one of the pre-authorized user credentials;
if the user login credentials are determined to match one of the pre-authorized user credentials, requesting and receiving a computed geolocation for the user device from a trusted source;
determining, using the public device ID, whether the computed geolocation matches one of the pre-authorized user device geolocations; and
if the computed geolocation is determined to match one the pre-authorized user device geolocations, validating that the user device is authorized to have access to the resource or the service of the provider.

9. The method of claim 8, wherein the trusted source is a network comprising a number of satellites.

10. The method of claim 8, further comprising, in response to validating that the user device is authorized to have access to the resource or the service of the provider, generating and transmitting a resource access response to the trusted source indicating that access has been authorized.

11. The method of claim 1, wherein the determining whether the computed geolocation matches one of the pre-authorized user device geolocations comprises determining whether the computed geolocation is within predetermined geolocation error bounds of one the pre-authorized user device geolocations.

12. A trusted network system for use in determining whether a user device is authorized to have access to a resource or service of a provider, the user device having a user device unique ID that is stored on the user device and the provider having a provider unique device ID that is stored on a device of the provider, comprising:
a plurality of cluster member satellites; and
an authentication system provided on one of the cluster member satellites, the authentication system including a certifying authority and a database, wherein the database stores a plurality of pre-authorized provider unique IDs, a plurality of pre-authorized provider geolocations, and a plurality of pre-authorized user device unique IDs, wherein the certifying authority is structured and configured to:
(i) receive a public device ID of the device of the provider and the provider unique ID;
(ii) determine whether the provider unique ID matches one of the pre-authorized provider unique IDs;
(iii) if the provider unique ID is determined to match one of the pre-authorized provider unique IDs, compute a geolocation for the device of the provider and determine, using the public device ID of the device of the provider, whether the computed geolocation matches one of the pre-authorized provider geolocations;
(iv) if the computed geolocation is determined to match one of the pre-authorized provider geolocations, receive a public device ID of the user device and the user device unique ID; and
(v) determine, using the public device ID of the user device, whether the user device unique ID matches one of the pre-authorized user device unique IDs.

13. The system of claim 12, wherein the certifying authority is structured and configured to determine whether the computed geolocation matches one of the pre-authorized provider geolocations by determining whether the computed geolocation is within predetermined geolocation error bounds of one the pre-authorized provider geolocations.

14. A trusted network authentication method for use in determining whether a user device is authorized to have access to a resource or service of a provider, the user device having a user device unique ID that is stored on the user device and the provider having a provider unique device ID that is stored on a device of the provider, the method comprising:
storing a plurality of pre-authorized provider unique IDs, a plurality of pre-authorized provider geolocations, and a plurality of pre-authorized user device unique IDs in a database of an authentication system provided on a cluster member satellite;
receiving a public device ID of the device of the provider and the provider unique ID;
determining whether the provider unique ID matches one of the pre-authorized provider unique IDs;
if the provider unique ID is determined to match one of the pre-authorized provider unique IDs, computing a geolocation for the device of the provider and determining, using the public device ID of the device of the provider, whether the computed geolocation matches one of the pre-authorized provider geolocations;
if the computed geolocation is determined to match one of the pre-authorized provider geolocations, receiving a public device ID of the user device and the user device unique ID; and
determining, using the public device ID of the user device, whether the user device unique ID matches one of the pre-authorized user device unique IDs.

15. The method of claim 14, wherein the determining whether the computed geolocation matches one of the pre-authorized provider geolocations comprises determining whether the computed geolocation is within predetermined geolocation error bounds of one the pre-authorized provider geolocations.

16. An authentication system for use in determining whether a user device is authorized to have access to a resource or service of a provider, the user device having a user device unique ID that is stored on the user device and a user device public device ID, comprising:
a certifying authority and a database, wherein the database stores a plurality of pre-authorized user device public device IDs, wherein the certifying authority is structured and configured to:
(i) receive, in response to an authentication request, the user device unique ID and the user device public device ID;
(ii) determine whether the received user device public device ID matches one of the pre-authorized user device public device IDs based on the received user device unique ID; and
(iii) successfully authenticate the user device if it is determined that the received user device public device ID matches one of the pre-authorized user device public device IDs.

17. The system according to claim 16, wherein the user device unique ID is hardwired on the user device at the time of its manufacture and is neither programmable nor editable.

18. The system according to claim 16, wherein the certifying authority is part of a trusted network comprising a number of satellites.

19. An authentication method for use in determining whether a user device is authorized to have access to a resource or service of a provider, the user device having a user device unique ID that is stored on the user device and a user device public device ID, the method comprising:
storing a plurality of pre-authorized user device public device IDs;
receiving, in response to an authentication request, the user device unique ID and the user device public device ID;
determining whether the received user device public device ID matches one of the pre-authorized user device public device IDs based on the received user device unique ID; and
successfully authenticating the user device if it is determined that the received user device public device ID matches one of the pre-authorized user device public device IDs.

20. An immutable factor authentication system for determining whether a user device is authorized to have access to a resource or service of a provider, the user device having a user device unique ID that is stored on the user device, comprising:
an access control engine; and
a credential database, wherein the credential database stores a plurality of pre-authorized user device geolocations, wherein the access control engine is structured and configured to:
(i) store a plurality of pre-authorized user device geolocations;
(ii) receive an authentication message from a trusted source indicating that the user device has been successfully authenticated using the user device unique ID;
(iii) responsive to the receipt of the authentication message, request and receive a computed geolocation for the user device from the trusted source;
(iv) determine whether the computed geolocation matches one the pre-authorized user device geolocations; and
(v) if the computed geolocation is determined to match one the pre-authorized user device geolocations, validate that the user device is authorized to have access to the resource or the service of the provider.

21. The system according to claim 20, wherein the user device unique ID is hardwired on the user device at the time of its manufacture and is neither programmable nor editable.

22. The system according to claim 20, wherein trusted source comprises a network comprising a number of satellites.

23. The system according to claim 20, wherein the user device has a user device public device ID, and where the authentication message is generated using the user device unique ID and the user device public device ID.

24. An immutable factor authentication method for determining whether a user device is authorized to have access to a resource or service of a provider, the user device having a user device unique ID that is stored on the user device, the method comprising:
storing a plurality of pre-authorized user device geolocations;
receiving an authentication message from a trusted source indicating that the user device has been successfully authenticated using the user device unique ID;
responsive to the receipt of the authentication message, requesting and receiving a computed geolocation for the user device from the trusted source;
determining whether the computed geolocation matches one the pre-authorized user device geolocations; and
if the computed geolocation is determined to match one the pre-authorized user device geolocations, validating that the user device is authorized to have access to the resource or the service of the provider.

25. The method according to claim 24, wherein the user device has a user device public device ID, and where the authentication message is generated using the user device unique ID and the user device public device ID.

26. An immutable factor authentication method for determining whether a user device is authorized to have access to a resource or service of a server, the user device having a public device ID, the method comprising
storing a plurality of pre-authorized user device geolocations;
requesting and receiving a plurality of computed geolocations for the user device from a trusted source using the public device ID;
for each of the computed geolocations, determining whether the computed geolocation matches one of the pre-authorized user device geolocations;
responsive to determining that each of the computed geolocations matches one of the pre-authorized user device geolocations, running location analytics on the plurality of computed geolocations to determine a number of geolocation differential values from pairs of the computed geolocations;
determining from the number of geolocation differential values whether physical movement of the user device violates predetermined motion constraints; and
determining that malicious activity may have occurred responsive to determining that the physical movement of the user device violates the predetermined motion constraints.

27. The method according to claim 26, wherein the server is a banking server.
